(19) United States
(12) Patent Application Publication
(10) Pub. No.: US 2004/0004623 A1
(43) Pub. Date: Jan. 8, 2004

(54) Apparatus, systems, and methods to control image transparency

(75) Inventor: John David Miller, Portland, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/420,140

(22) Filed: Apr. 21, 2003

Related U.S. Application Data
(63) Continuation of application No. 09/210,055, filed on Dec. 11, 1998.

(51) Int. Cl. G09G 5/02

(52) U.S. Cl. 345/592

(57) ABSTRACT

A method and system for controlling the transparency of object in a displayed image is disclosed. In one embodiment of the invention, a method of modulating the transparency of a displayed image of an object is described. In another embodiment, a system in which a standard graphics engine takes as input a modulating factor in order to modulate the transparency of a displayed image is described.

This application is a continuation of U.S. patent application Ser. No. 09/210,055, filed Dec. 11, 1998, which is incorporated herein by reference.

### TECHNICAL FIELD

This invention relates generally to image display systems, and, more particularly, to controlling the transparency of displayed images.

### BACKGROUND

As computing engines become more powerful, three dimensional graphic scenes are becoming easier to create and more common. They are especially common in scientific visualization applications, such as medical and geographical imaging.

Three dimension graphic scenes often contain a significant amount of information that is layered, and in many cases, the foreground objects obscure portions of the background objects. For example, in the display of a human thorax in a medical imaging application, a rib may obscure a portion of the heart.

Users of three dimensional graphic scenes are often interested in a background object and the spatial relationship between a foreground object and the background. For example, in the medical imaging example described above, a surgeon may interested in viewing the heart and the spatial relationship between the heart and the rib. In current three dimensional imaging systems, the rib may be removed from the image in order to view the heart, but this eliminates some of the information of interest, namely, the spatial relationship between the heart and rib. For these and other reasons, there is a need for embodiments of the present invention.

### SUMMARY OF THE INVENTION

A method and apparatus for controlling image transparency are described. In one embodiment of the invention, a method for controlling the transparency of an image of an object includes modulating the transparency of the image as a function of an angle of incidence of a vector normal to a viewing surface and the surface of the object.

In different embodiments of the invention, computers, displays, and magnetic storage media of varying scope are described. Still other advantages, embodiments, and aspects of the invention will become apparent by reference to the drawings and by reading the following description.

### BRIEF DESCRIPTION OF THE DRAWINGS

FIG. 1 is a diagram showing method and system embodiments of the present invention.

FIG. 2 is a diagram showing a general flow diagram of one embodiment of a method of the present invention.

### DETAILED DESCRIPTION

In the following detailed description of example embodiments of the invention, reference is made to the accompanying drawings which form a part hereof, and in which is shown by way of illustration specific example embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of this disclosure. The following detailed description is, therefore, not to be taken in a limiting sense, and the scope of various embodiments is defined only by the appended claims.

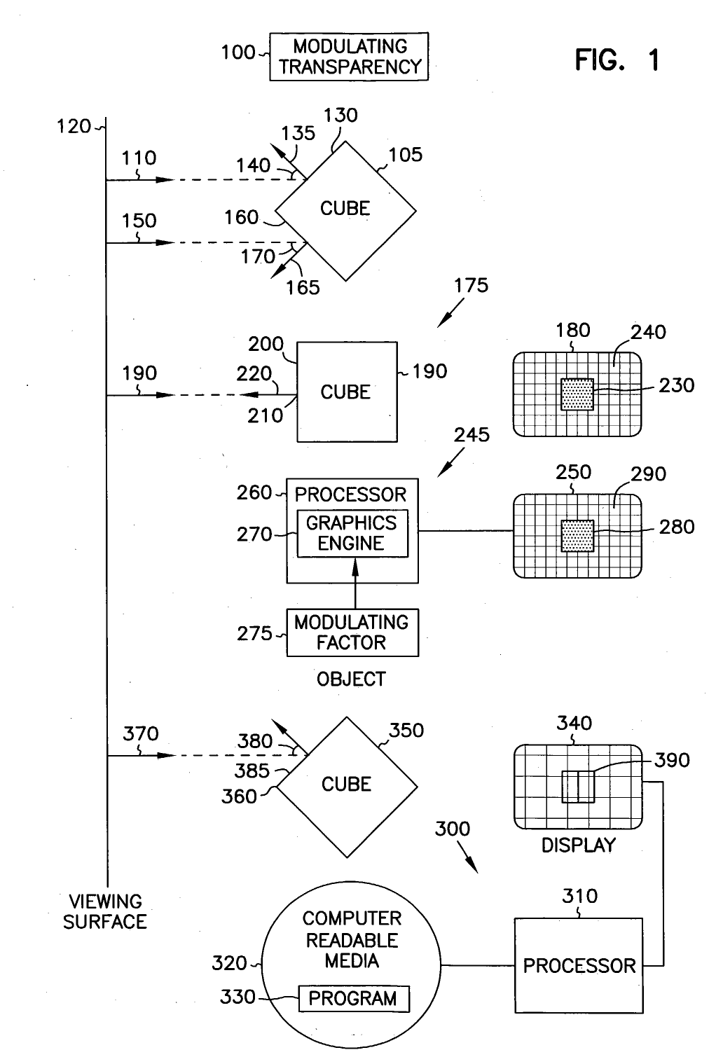

Referring to FIG. 1, one embodiment of a method of the present invention is shown. The embodiment comprises modulating transparency 100 of an image of an object. Modulating the transparency of an image is defined as varying the transparency over a range. For example, the transparency of an image can vary from opaque to clear. An opaque image permits no light from an image behind the opaque image to be viewed. A clear image permits all light from an image behind the opaque image to be viewed. As transparency progresses from opaque to clear, the amount of viewable light emanating from images behind the image whose transparency is being modulated increases.

In a graphics processing system, the transparency of a displayed image is controlled by a parameter, in one embodiment a transparency factor, having a value of between zero and one. An image associated with a transparency factor of one is opaque, while an image associated with a transparency factor of zero is transparent. As the transparency factor increases from zero to one, the opacity of the displayed image increases. Those skilled in the art will recognize that in a graphics processing system, a complex object, such as a sphere, is represented by a large number of transparency factors, one for each incremental element of the surface of the sphere.

The transparency factor in one embodiment is a function of the angle of incidence formed by the intersection of the viewing surface normal vector with the object surface normal vector. For example, in FIG. 1, a top view of cube 105 is shown, and normal vector 110 with respect to viewing surface 120 intersects cube surface 130 at the base of normal vector 135, creating an angle of incidence 140. Similarly, normal vector 150 with respect to viewing surface 120 intersects cube surface 160 at the base of normal vector 165, creating an angle of incidence 170. Those skilled in the art will recognize that the viewing surface 120 is the location of a camera for providing a perspective in a three-dimensional graphics system.

A variety of functions, including linear and nonlinear functions, can operate on an angle of incidence to generate a transparency factor. For example, assuming angle of incidence 140 is twenty-five degrees, then a cosine function operating on twenty-five degrees results in a transparency factor of 0.906. Similarly, assuming angle of incidence 170 is sixty-five degrees, then a cosine function operating on sixty-five degrees results in a transparency factor of 0.422.

When an image of cube 105 is displayed, cube surface 130, having a transparency factor of 0.906, appears almost opaque, while cube surface 160, having a transparency factor of 0.422, appears more transparent than opaque.

An advantage of this embodiment of the invention is that it is easily applied to existing image data. The information employed, surface normals and viewing surfaces, is part of the data associated with objects in current visualization systems.

In an alternate embodiment of the invention, system 175 comprises viewing surface 120 and display 180. Viewing surface 120 defines a perspective from which an object, such as cube 190, is viewed. A display, suitable for use in this embodiment, is any device that displays images, such as a cathode ray tube or a flat panel display. The particular technology in which the display is implemented is not critical to the practice of this embodiment of the invention.

In system 175, normal vector 190 is associated with viewing surface 120. Normal vector 190 in conjunction with normal vector 210 defines an angle of incidence 220. Since cube surface 200 is parallel to viewing surface 120, angle of incidence 220 in this example is zero.

The transparency of image 230 is modulated as a function of angle of incidence 220. For a cosine modulating function, since the cosine of zero is one, the transparency factor is one, and image 230 projected on display 180 is opaque. Opaque image 230 obscures background 240. If cube 190 is rotated, so that cube surface 200 is no longer parallel to viewing surface 120, then image 230 becomes less opaque and background 240 is no longer obscured.

In another embodiment, system 245 comprises viewing surface 120, display 250, processor 260 operatively coupled to display 250, and graphics engine 270 running on processor 260. Viewing surface 120 has been described above, and display 250, which is the same as display 180, has also been described above.

The selection of processor 260 is not critical to the practice of this embodiment of the present invention. Virtually any processor, for example, a microprocessor, a mainframe processor, or a minicomputer processor, is suitable for use in this embodiment.

An advantage of this embodiment is that graphics engine 270 may be a standard graphics engine currently used in image display systems. The only requirement is that engine 270 be capable of modulating the transparency of an object, as described above, from a parameter input. For example, engine 270 receives as an input signal a transparency modulating factor between zero and one. An input signal of zero directs the engine 270 to display the associated object as transparent, and an input signal of one directs the engine 270 to display the associated object as opaque.

In operation, modulating factor 275 is generated as described above and input to graphics engine 270. For example, a cosine function applied to an angle of incidence of zero at cube face 200 yields a modulating factor of one. The factor is input to graphics engine 270, and processor 260 drives display 250 to display opaque cube surface image 280 on display 250. Background 290 is obscured by the opaque image 280.

In another embodiment of the invention, computer system 300 comprises processor 310, computer-readable media 320, computer program 330, and display 340. Virtually any processor, such as a microprocessor, mainframe processor, or a minicomputer processor, is suitable for use in this embodiment of the present invention. Similarly, the particular computer-readable media 320 selected is not critical to the practice of this embodiment. Suitable computer-readable media include magnetic storage, optical storage, and semiconductor memory. Any display 340, such as a cathode ray tube or a flat panel display, is suitable for use in this embodiment.

Computer program 330 is executed from computer-readable media 320 by processor 310. The program 330 modulates the transparency of an image as a function of an angle of incidence of a vector normal to a viewing surface at a surface of an object. For example, cube 350 is oriented with edge 360, which is an edge of cube face 385, parallel to viewing surface 120. Viewing surface normal vector 370 creates an angle of incidence 380 with the cube face normal vector. The angle of incidence 380 with the cube face normal vector is forty-five degrees, and assuming a cosine modulating function, the image of cube face 385 is displayed as a partially transparent cube face 390 on display 340, since the cosine of forty-five degrees is 0.707.

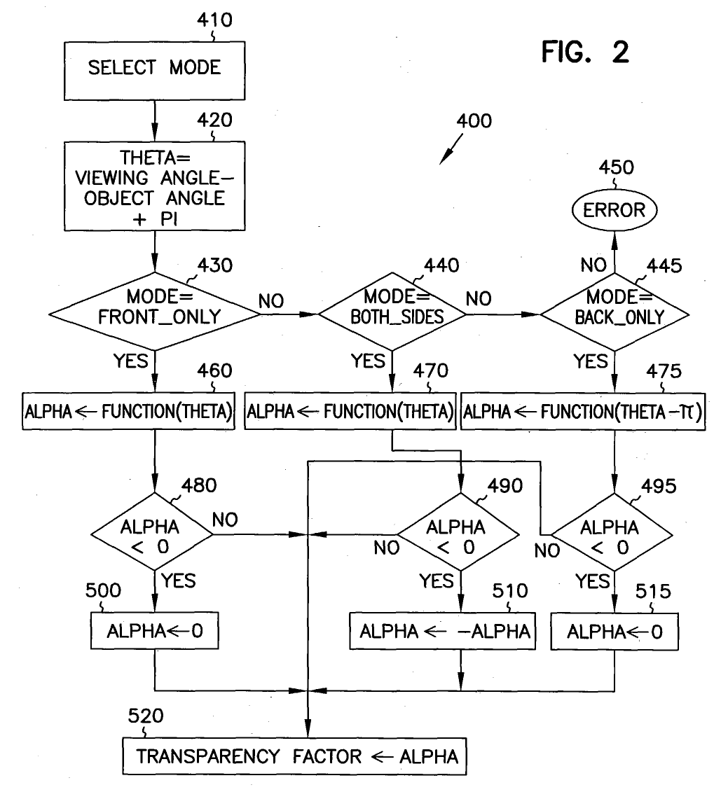

Referring to FIG. 2, a general flow diagram of one embodiment of a method 400 for generating a transparency factor is shown. The method 400 includes selection 410 between a FRONT_ONLY mode, a BOTH_SIDES mode, and a BACK_ONLY mode. The method 400 operates in one of three modes. In the FRONT_ONLY mode, a transparency factor, calling for opacity when the front view of the object is perpendicular to the viewing vector, is generated. In the BOTH_SIDES mode, a transparency factor, calling for opacity when either the front view of the object or the back view of the object is perpendicular to the viewing vector, is generated. In the BACK_ONLY mode, a transparency factor, calling for opacity when the back view of the object is perpendicular to the viewing vector, is generated.

Method 400 includes determining a viewing angle, determining an object angle, and calculating THETA 420. To determine the viewing angle and the object angle a coordinate system is established in an x-y plane that includes a normal vector with respect to a viewing surface and a normal vector with respect to an object surface. The normal vector with respect to the viewing surface is the vector from which the viewing angle is determined, and the viewing angle is the angle the viewing normal vector makes with the x-axis of the coordinate system. The object vector is a normal vector with respect to the surface of the object, and the object angle is the angle the object normal vector makes with the x-axis of the coordinate system. THETA is the viewing angle minus the object angle plus PI.

Determining whether the FRONT_ONLY mode, the BOTH_SIDES mode, or the BACK_ONLY mode is selected occurs in decision blocks 430, 440, and 445. If none of the three modes is selected, then an error state 450 is entered.

Assigning a function of THETA to ALPHA is shown in blocks 460 and 470. Assigning a function of THETA-π to ALPHA is shown in block 475. The function applied to THETA and THETA-π can be a linear function or a non-linear function. For example, a cosine function can be applied to THETA to generate cosine(THETA).

Comparing alpha to zero is shown in decision blocks 480, 490, and 495. Assigning zero to ALPHA, if ALPHA is less than zero and the MODE is FRONT_ONLY, is shown in block 500, and assigning zero to ALPHA, if ALPHA is less than zero and the MODE is BACK_ONLY, is shown in block 515. Assigning minus ALPHA to ALPHA, if ALPHA is less than zero and the MODE is BOTH_SIDES, is shown in block 510, and assigning the transparency factor to ALPHA is shown in block 520.

An advantage of this embodiment is the simplicity of the method in terms of process flow, and the small number of calculations to generate a transparency factor. For example, only two types of decisions are employed and only two types of calculations are employed. The decisions this particular embodiment employs are the mode decision in blocks 430, 440, and 445 and the polarity of ALPHA decision in blocks 480, 490, and 495. The calculations employed are the arithmetic calculation of THETA in block 420 and the application of a function to THETA in blocks 460, 470, and 475. The simplicity of the method makes the implementation of the method very cost effective.

Although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein, will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

What is claimed is:

1. A method, comprising:
identifying a vector normal to a viewing surface and incident at an object surface of an object, the vector having an angle of incidence at the object surface; and
modulating the transparency of an image of the object as a function of the angle of incidence.

2. The method of claim 1, wherein the function comprises a linear function.

3. The method of claim 1, wherein the transparency of the image is modulated from opaque to clear.

4. The method of claim 3, wherein a transparency factor associated with the image has a value of about zero to about one.

5. The method of claim 1, wherein the object surface is a face of a cube.

6. A method, comprising:
selecting a viewing surface;
selecting a vector normal to the viewing surface;
determining an angle of incidence at a surface of an object, the angle of incidence being created by the vector normal to the viewing surface; and
calculating a transparency factor for an image of the object from the angle of incidence.

7. The method of claim 6, wherein calculating the transparency factor further comprises:
calculating a linear function of the angle of incidence.

8. The method of claim 6, further comprising:
calculating a plurality of transparency factors corresponding to a plurality of surfaces associated with the object.

9. The method of claim 6, further comprising:
determining whether the transparency factor is to be associated with opacity when a front view of the object is perpendicular to the vector.

10. The method of claim 6, further comprising:
determining whether the transparency factor is to be associated with opacity when either a front view of the object or a back view of the object is perpendicular to the vector.

11. The method of claim 6, further comprising:
determining whether the transparency factor is to be associated with opacity when a back view of the object is perpendicular to the vector.

12. A system, comprising:
a processor;
a computer-readable medium; and
a computer program capable of being executed from the computer-readable medium by the processor to modulate the transparency of an image of an object as a function of an angle of incidence of a vector at a surface of the object, the vector being normal to a viewing surface.

13. The system of claim 12, further comprising:
a graphics engine to receive a transparency factor associated with the angle of incidence of the vector at the surface of the object.

14. The system of claim 12, further comprising:
a display to display the image of the object.

15. The system of claim 12, wherein the computer-readable medium is a semiconductor memory.

16. A computer readable medium having computer-executable instructions stored thereon for performing a method of modulating the transparency of an image, the method comprising:
modulating the transparency of an image of an object as a function of an angle of incidence of a vector at the surface of an object, the vector being normal to a viewing surface.

17. The computer readable medium of claim 16, where the method further comprises:
modulating the transparency linearly.

18. The computer readable medium of claim 16, wherein the transparency of the image is associated with a transparency factor of about zero if the image is to be displayed as transparent.

19. The computer readable medium of claim 16, wherein the transparency of the image is associated with a transparency factor of about one if the image is to be displayed as opaque.

20. A method, comprising:
identifying a normal vector associated with a surface of an object; and
generating a transparency factor associated with an image of the object based on an angle of incidence formed by the intersection of the normal vector associated with the surface of the object and a viewing surface normal vector.

21. The method of claim 20, wherein the transparency of the image is modulated from opaque to clear.

22. The method of claim 20, wherein the viewing surface normal vector is associated with a viewing surface comprising a camera location to provide a perspective in a three-dimensional graphics system.

23. The method of claim 20, further comprising:
modulating a transparency of the image using the transparency factor.

24. The method of claim 20, wherein a graphics engine is used for modulating the transparency of the image.
